(19) United States
(12) Patent Application Publication
(10) Pub. No.: US 2024/0330187 A1
(43) Pub. Date: Oct. 3, 2024

(54) COST-AWARE CACHING OF OBJECTS FROM A DATA STORE

(71) Applicant: Teradata US, Inc., San Diego, CA (US)

(72) Inventor: Yang Xiang, San Diego, CA (US)

(73) Assignee: Teradata US, Inc., San Diego, CA (US)

(21) Appl. No.: 18/129,397

(22) Filed: Mar. 31, 2023

Related U.S. Application Data
(60) Provisional application No. 63/478,143, filed on Dec. 31, 2022.

(51) Int. Cl. G06F 12/0831; G06F 12/0813; G06F 12/0893

(52) U.S. Cl. CPC G06F 12/0835; G06F 12/0813; G06F 12/0893; G06F 2212/1024

(57) ABSTRACT

A system and method for caching data objects retrieved from a network object store or cloud storage remotely accessible by a database management node. Retrieved data objects are stored within the database management node in a cache memory having multiple cache zones providing different input/output (I/O) latencies with respect to cache data access. Retrieved data objects are placed within the cache zones in accordance with access and storage costs associated with the retrieved data objects, wherein data objects having higher associated costs are placed in cache zones having lower I/O latencies. The costs associated a data object may be determined from object store vendor costs, object store storage tier levels, locations of the data management node and the object store, method of connection to the object store, or read from a pricing matrix containing predetermined object costs associated with stored data objects.

### FIELD OF THE INVENTION

This invention relates generally to database management systems and external object storage systems, and more particularly to improved methods for caching object data within database management systems employing external cloud storage, such as public and private cloud storage solutions including Amazon Web Services (AWS), Microsoft Azure, Google Cloud, and IBM Cloud, and others.

### BACKGROUND OF THE INVENTION

A relational database management system (DBMS) stores databases that include collections of logically related data arranged in a predetermined format, such as in tables that contain rows and columns. To access the content of a table in a database, queries according to a standard database query language (such as the Structured Query Language or SQL) are submitted to the DBMS. A query can also be issued to insert new entries into a table of a database (such as to insert a row into the table), modify the content of the table, or to delete entries from the table.

Examples of SQL statements include SELECT, INSERT, UPDATE, and DELETE.

In other examples, object stores can be used to store objects that can have a different form than rows of a table in a relational DBMS. The object stores can be provided in a cloud that is accessible over a network, for example. Unfortunately, when retrieving objects from a network-based external storage, performance can be negatively impacted by latency and object store vendors access constraints.

### BRIEF DESCRIPTION OF THE DRAWINGS

Some implementations of the present disclosure are described with respect to the following figures.

FIG. 1 is a block diagram of an example arrangement that includes database management nodes and an object-based remote data store.

FIG. 2 is a block diagram of an object metadata.

FIG. 3 is a flow diagram of a process for caching objects from an object data store.

FIG. 4 illustrates the relative differences in data access times and costs for non-volatile memory express (NVME) devices, SSD storage devices, and elastic block store (EBS) cloud storage devices, and other components of an object store cache system.

FIG. 5 illustrates an object store cache system employing a cache memory and configurable cache zones providing caching needs based on the size and expenses associated with different object store access tiers in accordance with the present invention.

FIG. 6 illustrates an implementation of a cost-based cache replacement policy in accordance with the present invention.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF THE INVENTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

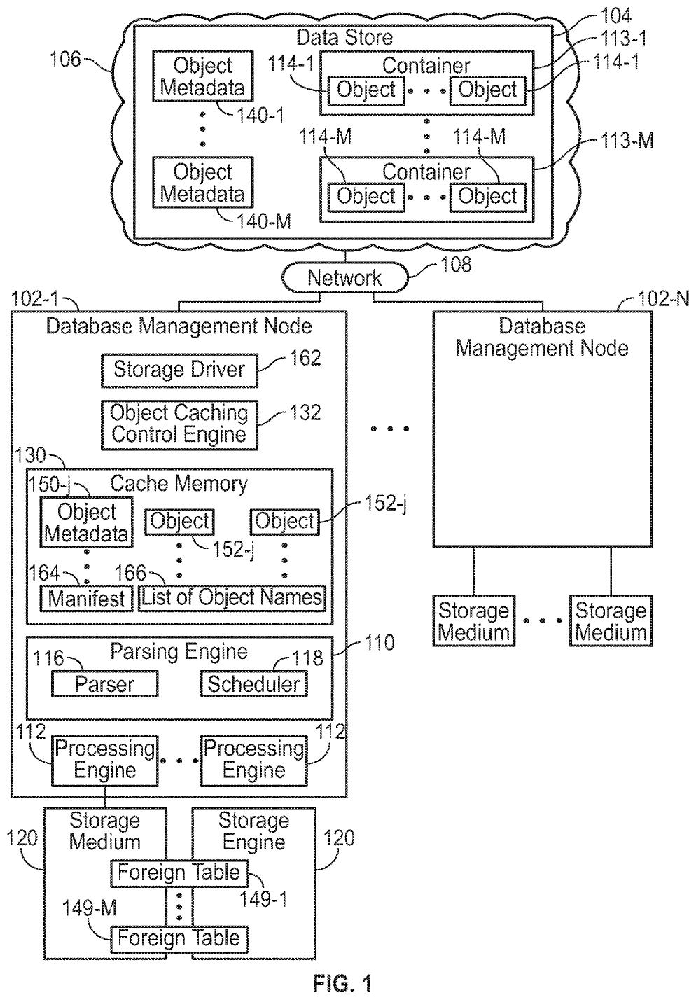

FIG. 1 is a block diagram of an example arrangement that includes database management nodes 102-1 to 102-N, where N>1, and a remote data store 104. Note that in some examples, just one database management node is present. A “node” can refer to a computer or a collection of computers, where each computer can include one or more processors. A processor can include a microprocessor, a core of a multi-core microprocessor, a microcontroller, a programmable integrated circuit, a programmable gate array, or another hardware processing circuit. The database management node(s) is (are) part of a relational database management system (DBMS).

In some examples, the data store 104 is an object store that stores objects. The data store 104 can be implemented using one or more storage devices, such as a disk-based storage device, a solid state storage device, and so forth.

As used here, an “object” can refer to any separately identifiable or addressable unit of data. In some examples, an object may also be referred to as a blob. Generally, an object can store data records in a form that is different from a relational table that is used in a relational DBMS. When an object is loaded from the data store 104 into a database management node 102-i (i=1 to N), the data records in the object can be populated into one or more tables stored by the database management node 102-i.

In the example of FIG. 1, the data store 104 stores objects in respective containers 113-1 to 113-M (M>1). Although multiple containers are shown in FIG. 1, in other examples, the data store 104 can include just one container, or alternatively, the concept of containers is not employed by the data store 104. Each container 113-j (j=1 to M) includes one or more objects 114-j. Generally, a “container” can refer to a data structure (analogous to a directory) that can contain further data, such as the objects shown in FIG. 1.

The objects 114-j of the data store 104 can have variable sizes, and each object can have a size between 10 megabytes (MB) and 100 MB and possibly up to a few terabytes (TB), for example. In other examples, an object can have a smaller or larger size. An object in an object store is typically larger in size than data records, e.g., rows, tables, etc., stored in a local storage, e.g., 120 in FIG. 1, of a DBMS.

In some examples, the data store 104 can be provided in a cloud 106. A “cloud” can refer to any infrastructure, including computing, storage, and communication resources, that can be accessed remotely by computing devices over a network, such as a network 108 shown in FIG. 1. Alternatively, the data store 104 can be provided in a data center or in any other computing environment.

The network 108 can include a public network, e.g., the Internet; a local area network (LAN); a wide area network (WAN); a wireless network, e.g., a wireless local area network or WLAN; a cellular network; etc.; or any other type of network.

The following describes components of the database management node 102-1. The database management node 102-N has the same or similar components.

The database management node 102-1 includes a parsing engine 110 that is able to process SQL queries, including data definition language (DDL) statements and data manipulation language (DML) statements. More generally, the parsing engine 110 is able to process database queries received from requesters, not shown, which can include users or programs in client computing devices. The client computing devices may be coupled to the relational DBMS, including the database management nodes 102-1 to 102-N, over a network, such as the network 108.

In addition to the parsing engine 110, the database management node 102 includes multiple processing engines 112. In other examples, the database management node 102-1 can include just one processing engine 112.

As used here, an “engine” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, an “engine” can refer to a combination of a hardware processing circuit and machine-readable instructions (software and/or firmware) executable on the hardware processing circuit.

Traditionally, a DBMS, e.g., a database management node, stores data in relational databases in a local block-based storage, in which data is stored as blocks that are smaller in size than objects of object stores. For example, a block-based storage (e.g., storage media 120 shown in FIG. 1) can include one or more disk-based storage devices, one or more solid state storage devices, and so forth.

The block-based storage, e.g., storage media 120 shown in FIG. 1, can be connected to the database management node over a relatively high-speed communication link, possibly through one or more switches or routers or other network devices, such that the database management node can access (read or write) data in a relational database with relatively low input/output (I/O) latency, i.e., the delay between a time that a data request is submitted and a time that the data request is satisfied at the block-based storage is relatively low. The block-based storage can be considered a local storage of the DBMS, since the DBMS is able to access the block-based storage with relatively low I/O latency.

Although FIG. 1 depicts the storage media 120 as being outside of the database management node 102-1, it is noted that the storage media 120 can be included in the database management node 102-1 in other examples.

In some examples, instead of or in addition to coupling local block-based storage to the database management node 102-1, the database management node 102-1 can access the data store 104, which can be provided in the cloud 106 or another remote computing environment.

The multiple processing engines 112 are able to execute in parallel to request access of different data portions in the storage media 120 and/or in the data store 104. The processing engines 112 executing in parallel can allow for fuller utilization of the available bandwidth over the network 108 to the data store 104.

Each processing engine 112 is considered a Unit of Parallelism (UOP) that is able to execute in parallel, e.g., concurrently or simultaneously, with one or more other UOPs. Each UOP is able to perform a local relational operation, such as a join operation, e.g., to join data from multiple tables; a data aggregation operation to aggregate multiple pieces of data into an aggregate value, such as a sum, maximum, minimum, average, median, etc.; an ordered analytic operation; and so forth. An ordered analytic operation refers to an operation that has an order specification specifying an order based on one or more attributes, e.g., sorting based on the one or more attributes, or an expression that performs some predetermined analysis, such as ranking, computing a moving average within a window size, calculating a cumulative total, calculating a percentile, and so forth.

When responding to a database query, the database management node 102-1 can retrieve one or more objects 114-j from the data store 104. In some examples, accessing data of the data store 104 can have a higher I/O latency than accessing data of the local block-based storage.

The parsing engine 110 of the database management node 102-1 can include a parser 116 and a scheduler 118. The parser 116 or scheduler 118 can be part of the hardware processing circuit of the parsing engine 110, or can include machine-readable instructions executable on the parsing engine 110.

The parser 116 receives database queries, such as SQL queries, load requests, etc., submitted by one or more requesters. The parser 116 parses each received database query and generates executable steps for the parsed query. The parser 116 includes an optimizer, not shown, that generates multiple query plans in response to a query. The optimizer selects the most efficient query plan from among the multiple query plans. Each query plan includes a sequence of executable steps to perform to process the database query. In some examples, the optimizer can prefetch a number of objects and associated size information from the containers 113-1 to 113-M, so that the optimizer can plan workloads for database queries. The scheduler 118 sends the executable steps of the selected query plan to respective one or more processing engines 112.

Each processing engine 112 can perform the following tasks in response to SQL queries or other requests parsed by the parsing engine 110: inserts, deletes, or modifies contents of tables or other data records; creates, modifies, or deletes definitions of tables or other data records; retrieves information from definitions and tables or other data records; locks databases and tables or other data records; and so forth.

As used here, a “data record” can refer to any unit of data that can be written into the data store 104. For example, the data record can be in the form of a row of a table, a table, a materialized view, or any other piece of data. Each data record can have multiple attributes. In a table row, the multiple attributes can be the multiple columns of the table row. Each attribute is assigned a value in the corresponding data record.

The database management node 102-1 is able to access the remote data store 104 using foreign tables 149-1 to 149-M. In examples where containers are used in the data store 104, the foreign tables 149-1 to 149-M correspond to the respective containers 113-1 to 113-M. Each foreign table 149-j (j=1 to M) stores information identifying a storage location of the respective container 113-j in the remote data store 104. The foreign table 149-j does not include the actual data of the objects 114-j in the container 113-j, such that the foreign table 149-j is much smaller in size than the collection of the objects 114-j in the container 113-j.

As noted above, retrieving an object from the data store 104 may be associated with a higher I/O latency than retrieving data from a local storage, such as in the storage media 120.

Thus, if each database query is to be satisfied by retrieving objects from the data store 104, then database system performance can suffer due to the relatively larger amount of time involved in retrieving data from the data store 104.

Another issue is that the data store 104 may be operated by an operator that is different from an operator of the database management nodes 102-1 to 102-N. In some cases, the operator of the data store 104 may charge a price for accessing an object from the data store 104. As a result, retrieving data from the remote data store 104 may be costly if a large number of database queries are to be satisfied based on accessing data in the data store 104.

To improve database performance and to reduce cost, a cache memory 130 in the database management node 102-1 may be used to cache objects 114-j retrieved from the data store 104. A cache memory 130 can be implemented using a memory device or a collection of memory devices. Examples of a memory device that can be used to implement the cache memory can include a flash memory device, a Non-Volatile Memory Express (NVMe) memory device, a solid-state drive (SSD), and so forth. The memory device may be non-volatile. A non-volatile memory device maintains the data stored in the non-volatile memory device even when power is removed from the non-volatile memory device or from a system in which the non-volatile memory device is located.

The storage capacity of the cache memory 130 is limited, such that there is a caching threshold set to store objects in the cache memory 130. If the size of objects stored in the cache memory 130 exceeds the caching threshold, then no further objects can be stored in the cache memory 130.

Moreover, the cache memory 130 may be used for caching data for database queries that do not access objects in the data store 104. If too much of the cache memory 130 is used to store objects such that insufficient space exists for other types of data, then the performance of database queries that access the local storage, e.g., 120, but not the data store 104 may be adversely impacted.

In accordance with some implementations of the present disclosure, the database management node 102-1 includes an object caching control engine 132 that performs a temperature-aware caching of objects retrieved from the data store 104.

In some examples, an object metadata may be associated with each container 113-j in the data store 104. As shown in FIG. 1, the data store 104 includes multiple object metadata 140-1 to 140-M that are associated with respective containers 113-1 to 113-M. Each object metadata 140-j (j=1 to M) can include multiple entries associated with respective objects 114-j of the corresponding container 113-j. For example, the object metadata 140-1 includes entries for respective objects 114-1 in the container 113-1, and the object metadata 140-M includes entries for respective objects 114-M in the container 113-M.

When one or more objects 114-j of a container 113-j are retrieved by the database management node 102-1 from the data store 104, a copy of the corresponding object metadata 140-j is also retrieved from the data store 104 and stored in the cache memory 130. The version of the object metadata 140-j retrieved from the data store 104 and stored in the cache memory is represented as object metadata 150-j. Also, objects 114-j retrieved from the data store 104 and stored in the cache memory 130 are represented as objects 152-j.

Note that in some examples, the object metadata 140-1 to 140-M can be retrieved from the data store 104 into the cache memory 130 without having to also retrieve the corresponding objects 114-1 to 114-M. In this manner, the object metadata 140-1 to 140-M retrieved into the cache memory 130 (and stored as object metadata 150-1 to 150-M) can be used for temperature-based caching of objects as performed by the object caching control engine 132.

Although initially the object metadata 150-j is a duplicate copy of the object metadata 140-j, the database management node object metadata 150-j may be changed with respect to the data store object metadata 140-j.

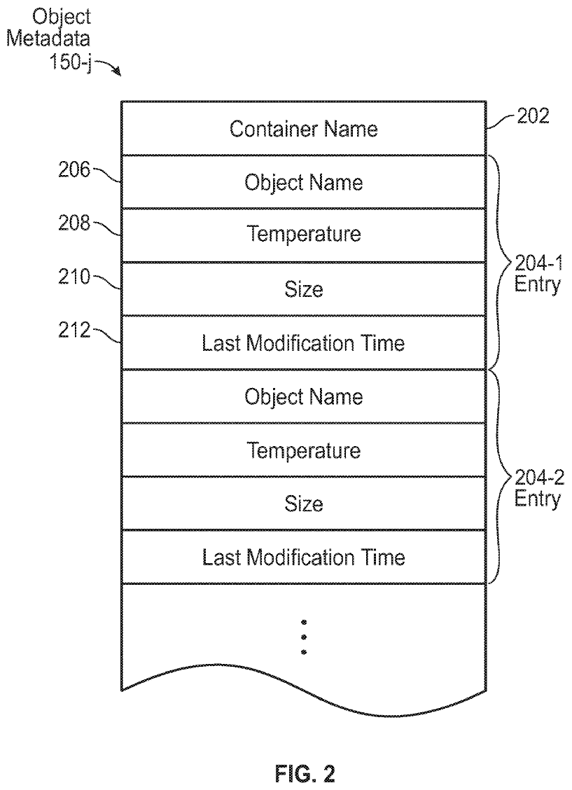

FIG. 2 illustrates an example of an object metadata 150-j. The object metadata 150-j includes a container name 202, which is the name of the container 113-j that the object metadata 150-j is associated with. The object metadata 150-j further includes multiple object metadata entries 204-1, 204-2, and so forth, for corresponding objects 114-j in the container 113-j. In some examples, the object metadata entry 204-1 for a respective object 114-1 includes the following fields: an object name field 206 (which includes a name of the object), a temperature field 208 (which includes a temperature indicating an amount of access of the object), a size field 210 (which includes a size of the object), and a last modification time field 212 (which includes a time that the object was last modified).

The remaining object metadata entries contain similar fields for other respective objects.

As used here, a “name”” can refer to any identifier of a container or an object. The identifier can be in numeric form, alphanumeric form, alphabetic form, and so forth.

A “temperature” can refer to a value that quantifies an amount of access, such as an access frequency, of an object. An access frequency represents a quantity of accesses of the object over a given time interval. In some examples, a temperature can be expressed as a numeric value that varies proportionally or inversely proportionally with the access frequency. In other examples, a temperature can be set to any of multiple discrete values (discrete numeric values or discrete temperature bands) that represent the access frequency.

The object caching control engine 132 (FIG. 1) can update one or more of the temperature field 208, the size field 210, and the last modification time field 212 in a corresponding object metadata entry in response to an access (read access or write access) of a corresponding object 152-j in the cache memory 130 (or a corresponding object 114-j in the data store 104). The temperature stored in the temperature field 208 is the last updated temperature for the respective object 152-j.

Although a specific collection of fields is depicted in FIG. 2 for each object metadata entry, it is noted that in other examples, object metadata entries can have different collections of fields.

As further shown in FIG. 1, the database management node 102-1 includes a storage driver 162 that manages the access of the data store 104 in response to requests from the processing engines 112.

Although not shown, the database management node 102-1 further includes a network interface to allow the database management node 102-1 to communicate over the network 108. The network interface can include a communication transceiver to transmit and receive signals over the network 108. The communication transceiver can include a wired transceiver and/or a wireless transceiver to perform wired and/or wireless communications over the network 108.

When an object is loaded into the database management node 102-1 from the data store 104, a manifest 164 in the database management node 102-1 can be updated. The storage driver 162 is able to determine one or more tables (such as the foreign tables 150 to 150-M) to which the loaded object corresponds. The manifest 164 can maintain a mapping between each object loaded into the database management node 102-1 and corresponding tables. The corresponding tables may be stored in the storage media 120.

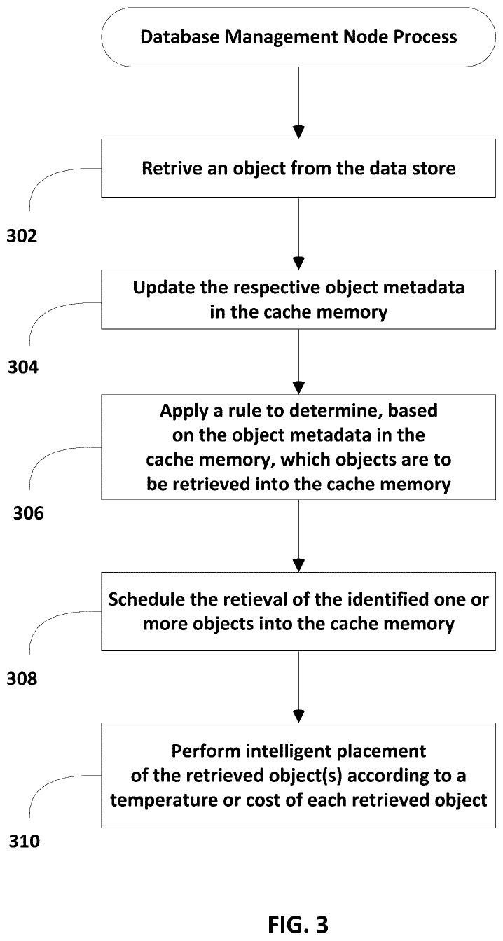

FIG. 3 is a flow diagram of a process that can be performed by a database management node, such as any of the database management nodes 102-1 to 102-N shown in FIG. 1. In response to retrieving (at 302) an object from the data store 104, the object caching control engine 132 updates (at 304) the respective object metadata (e.g., 150-j) in the cache memory 130 of the database management node. The fields corresponding to each accessed object can be updated, such as fields of a corresponding one of the metadata object entries 204-1, 204-2, and so forth, shown in FIG. 2.

In other examples, instead of updating the object metadata in response to access of each object, the object metadata updates may be performed on a periodic or other timer-based basis.

Among the fields that are updated is the temperature field 208 of the respective object that is accessed. The value in the temperature field 208 is updated each time the respective object is accessed. The value in the temperature field 208 for a more frequently accessed object would indicate a “hotter” object than the value of the temperature field for another object that is less frequently accessed. The hotness of an object represents an amount of access (e.g., access frequency) of the object. The hotness of an object can be measured over some specified time interval, such as over the course of a day, a week, a month, or some other specified time duration.

The object caching control engine 132 can also update other fields in the object metadata entry for an accessed object, such as the size field 210, the last modification time field 212, and so forth.

In examples where the database management node includes multiple processing engines, e.g., 112 in FIG. 1, the updating of the respective object metadata in the cache memory 130 can be based on aggregating, e.g., averaging, statistics relating to access of the objects in the data store by the multiple processing engines. For example, if two or more of the multiple processing engines have accessed a given object, then the update of the temperature for the given object is based on aggregating, e.g., averaging, the amount of access, e.g., access frequency, of the given object by each of the two or more processing engines, and the aggregated amount of access is then used to compute the updated temperature for the given object.

More generally, statistics associated with the accesses of the given object by the two or more processing engines are aggregated for producing an aggregated statistic, e.g., temperature, etc., that is then used to update the respective object metadata.

The object caching control engine 132 can apply (at 306) a rule to determine, based on the object metadata in the cache memory 130, which objects are to be retrieved from the data store 104 into the cache memory 130. The rule can be based on the temperature values of the objects, the sizes of the objects, a specified size of the portion of the cache memory 130 used to store objects, and any other criteria. Based on the rule, the object caching control engine 132 identifies one or more objects that are to be retrieved into the cache memory 130. For example, based on the rule, the object caching control engine 132 can sort the objects according to which ones are ranked higher for purposes of retrieving into the cache memory 130.

The ranking of the objects can be based on their respective temperature values. In further examples, the ranking of the objects can be based on their respective temperature values and their respective sizes. A higher temperature would tend to rank a given object higher, but a larger size would cause the rank to be reduced. Thus, the ranking of the given object may be based on a combination, e.g., a weighted aggregation, of the temperature value and the size value.

In further examples, identifying an object to retrieve from the data store 104 into the cache memory 130 can further be based on determining which of objects is (are) able to fit in the specified portion of the cache memory 130 allocated to cache objects. If an object would not fit or would take up too much of the specified portion of the cache memory 130, e.g., take up greater than a specified threshold percentage of the specified portion of the cache memory 130, then the object caching control engine 132 can decide to not select the object for caching.

The object caching control engine 132 schedules (at 308) the retrieval of the identified one or more objects from the data store 104 for storing into the cache memory 130. The scheduling identifies the time slots in which the identified one or more objects are to be retrieved from the data store 104. For example, the object caching control engine 132 can identify which time slots are less busy for the database management node, such as time slots after business hours. In other examples, the time slots in which retrieval of object(s) is scheduled can be based on a command that specifies the time slots to use.

Another factor in deciding, as part of the scheduling, when to retrieve the identified one or more objects into the cache memory 130 is the cost associated with retrieving the objects from the data store 104. The operator of the data store 104 may charge different costs to retrieve objects from the data store 104 at different times (higher prices during business hours). The object caching control engine 132 can schedule the retrieval of the identified objects in time slots to reduce the costs associated with object retrieval.

In some examples, the object caching control engine 132 can maintain a list of object names, e.g., a list 166 shown in FIG. 1, that lists the objects that are present in the cache memory 130. The list of objects 166 can also be stored in the cache memory 130.

After retrieving the identified one or more objects from the data store 104, the object caching control engine 132 can perform (at 310) intelligent placement of the retrieved object(s) according to a temperature of each retrieved object.

For example, the cache memory 130 may be implemented with multiple different memory devices, which may include a first memory device having a lower data access I/O latency, and a second memory device having a higher data access I/O latency. More generally, the different memory devices of the cache memory 130 may have respective different data access I/O latencies. In such examples, a hotter object would be placed in a faster memory device of the cache memory 130, while a less hot object would be placed in a slower memory device of the cache memory 130. For example, the multiple different memory devices of the cache memory 130 may be divided into multiple zones to accommodate different data temperatures, e.g., a hot zone, a warm zone, and a cold zone, or data costs.

Also, the cache memory 130 may be implemented with multiple memory devices at different locations within the database management node; in different database management nodes; or shared volumes, e.g. elastic block store (EBS) storage, on a cloud node.

Additional details concerning intelligent placement of objects retrieved from an object store to cache memory according to temperatures of the retrieved objects is provided in commonly assigned U.S. Pat. No. 11,520,789 entitled “CACHING OBJECTS FROM A DATA STORE” by Yang Xiang; incorporated by reference herein.

### Cache Zones and Object Store Tiers

Object store providers typically offer a range of storage classes or tiers to accommodate the different data access, resiliency, and cost requirements of customers workloads. Object store tiers may include a “hot” storage tier providing high performance access for frequently accessed data objects, a “cool” storage tier for storage of less frequently accessed data objects, and an “archival” storage tier for rarely accessed data objects. “Premium” storage tiers may also be provided by object store providers, offering higher performance for wokloads with high transactions rates or requiring faster access times.

Objects uploaded to the object store can be assigned to a storage tier selected by a customer or by default, with the storage tier assigned to an object determining its storage costs and any associated retrieval fees.

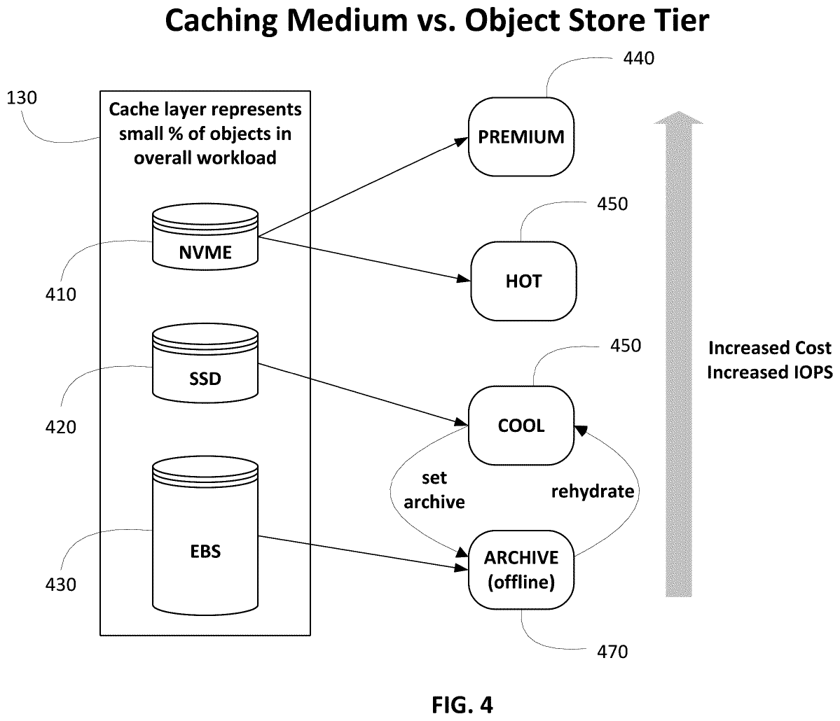

FIG. 4 provides an illustration of cache memory 130 implemented with multiple different memory devices, such as non-volatile memory express (NVME) devices 410, SSD storage devices 420, and elastic block store (EBS) cloud storage devices 430, wherein the different memory devices are employed to provide different caching performance for different tier levels within an object store. As illustrated, NVME devices 410 provide caching for object data retrieved from premium and hot storage tiers 440 and 450, respectively; SSD storage devices 420 provide caching for object data retrieved from cool storage tier 460; and EBS storage devices 430 provide caching for object data maintained in archive storage 470.

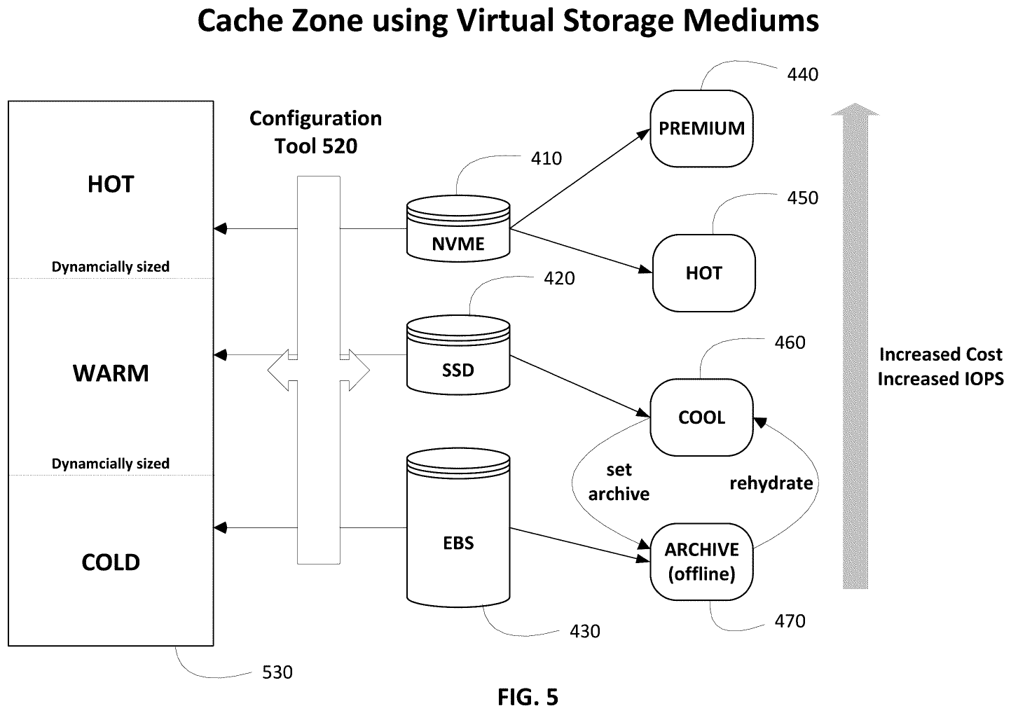

FIG. 5 illustrates an object store cache system employing a virtual cache memory 530 including configurable cache zones, e.g., HOT, WARM, and COLD zones, providing caching needs based on the size and expenses associated with different object store access tiers. Each zone is supported by local devices of fast, medium and slow storage medium, such as NVME 410, SSD 420, and EBS storage devices, respectively. This arrangement provides flexibility to expand the local cache capacity and use not only high performing storage devices such as NVME and SSD devices but also conventional HDD or shared volumes, e.g., EBS, on a cloud node. The reason behind this approach stems from the concept of Access Tiers offered by the cloud vendors for the network object stores. To that respect, instead of relying solely on fast devices such as NVME, the cache layer can use different storage mediums with varying IOPS bandwidth but still offers a performance advantage over the cloud and network fabric and reduce transfer costs by reading from local devices.

A configuration tool 520 is provided to take advantage of the various storage offerings by the cloud vendor to create the HOT, WARM, and COLD zones within virtual cache 530 based on device mapped stripes during the initial conception of the system and/or resize zones during the restart of the system based on runtime telemetry inputs.

In accordance with the cache system illustrated in FIG. 5, caching software executed during runtime, performs a lookup for an object in all zones and return the object to its user if it is found to be physically stored in any of its configured devices. Upon startup, a lookup table in memory is loaded per process and as the size of the cache zone(s) increases, the memory footprint will also increase for the caching software during runtime. On startup of a node, all cached objects are purged from local devices and cache zones reconfigured.

Benefits provided by the caching system include:

Caching becomes a cost aware operation, with configuration tool 520 providing a flexible way to accommodate caching needs based on the size and expenses associated with different access tiers.

Caching becomes more performant, not only based on object access patterns but also on object origin. Higher priority is assigned to cache objects from more expensive network storage tiers to maximize the caching benefits.

Additional opportunity for optimization in zone migration allows caching in higher priority objects during runtime in accordance with workload demands.

Spillover of cached objects into lower tier caching storage devices may be provided to entertain elasticity for a tactical workload when working with an Object File System.

### Cache Replacement

The techniques described above and illustrated in FIGS. 1 through 5 for caching object data retrieved from an external object store provide for improvements in database operations and queries involving data maintained within the object store. However, as stated earlier, the storage capacity of system cache memory 130 is limited. If the size of objects stored in the cache memory 130 exceeds the caching threshold, then no further objects can be stored in the cache memory 130, and the benefits provided by the object caching techniques described above may not be available for all object data maintained within the data store.

When cache 130 is full, the object caching control engine 132 executes an algorithm to select which cached objects to discard from cache memory 130 to make room for the new objects.

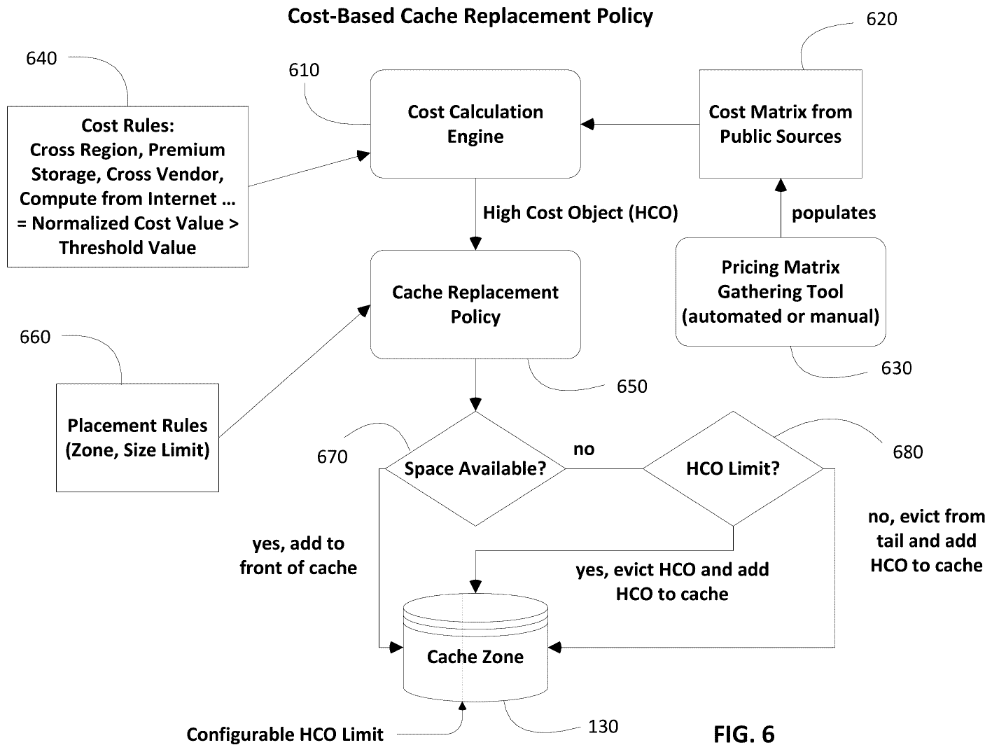

FIG. 6 illustrates an implementation of a cache replacement policy 650 executed by object caching control engine 132 to evict and replace objects stored within cache memory 130 in accordance with costs associated with objects retrieved from an object store.

A key feature of this implementation is that different cache replacement policies are deployed during runtime according to the properties of the objects inbound.

In this solution, cost-based calculations are employed not only for cache replacement but also for eviction determination when physical devices storing the cached objects become full or nearly full.

The cost calculation is accomplished through a cost calculation engine 610 which at startup takes input from a cost matrix 620 containing transfer costs associated with different object stores in various regions. The object costs contained within cost matrix 620 may be provided manually or automatically through utilization of a pricing matrix gathering tool 630.

As used here, a pricing matrix can refer to any list, file, table, document, or other data storage format accessible by cost calculation engine 610 containing transfer costs associated with data objects stored within different object stores and regions

A set of cost rules 640 are also used by cost calculation engine 610 to determine object costs. Some of the factors for cost calculation engine 610 to consider during evaluation of an object's cost are whether an object is a cross region objects, e.g., compute node in east region and object store in west region, which results not only higher cost but also slower IOPS; whether an object is from premium storage (cost is higher); whether an object is a cross vendor object (cost is much higher); and whether an object is accessed from an internet compute node (cost is much higher and transfer much slower). These factors can be retained in a set of cost rules 640 and the rules dynamically applied on startup so they are adaptive to the environment the system will be operating on.

In a hybrid storage environment, i.e., a storage infrastructure that uses a mix of on premises, private, or public cloud storage from multiple providers, the cost matrix 620 can be expanded to contain pricing information from one or many cloud vendors. An algorithm executed within the cost calculation engine 610 computes a normalized cost value for a potential object retrieval taking into consideration all costs associated with the object and its retrieval. When such value exceeds a preset threshold, the object is identified as a high-cost object (HCO).

The output of cost calculation engine 610 is a simple Yes/No to the question “high-cost object or not?” This output is provided to cache replacement policy 650 which uses a set of runtime rules 660 to determine where to place the object. Runtime rules 660 specify whether there is a size limitation for HCOs in the cache zone in which the object is to be potentially cached. If there is adequate space available in cache 130 (see 670), the object can be added to cache 130. If space is not available, and there is no HCO size limitation (see 680), an HCO always takes precedence over other objects, and eviction will occur to make room for the HCO. If there is an HCO size limitation, once the maximum size is reached, another HCO will be evicted from the corresponding cache zone, and the new HCO added.

Using the cost-based cache replacement policy shown in FIG. 6 and discussed above, a query for objects from an external object store that are taxed at a higher transfer cost and higher latency will take priority in the caching scheme and thus can be serviced more quickly and more cost efficiently from a local physical cache.

In the example discussed and illustrated, the cost-based cache replacement policy does not overrule an existing access pattern-based cache placement policy employed for object caching, but functions to enhance the caching decision process when determining which object to evict from cache or which zone in which to place an object so that higher cost objects are prioritized over lower value objects in the cache.

The caching techniques described herein provide a unique approach to solving complex join operations where multiple large foreign objects are required. By utilizing a local cache with a priority scheme based on a cost structure, a frequently deployed workload requesting large foreign objects can be serviced from a local cache with improved performance and lower vendor access cost.

By intelligently identifying which objects are to be cached in a database management node, the techniques and mechanisms described and suggested herein allow for more efficient caching of objects, enabling faster, lower cost access to objects that are traditionally stored in remote data stores associated with high I/O latencies.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A system comprising:
a database management node including a processor, a non-transitory storage medium containing instructions executable on said processor, and a cache memory, said cache memory having multiple cache zones providing different input/output (I/O) latencies with respect to cache data access;
an object store remotely accessible to the database management node for the storage of data objects, said object store including multiple storage tiers for said data objects, said storage tiers providing different input/output (I/O) latencies and costs with respect to data object access and storage; and
said instructions executable on said processor include instructions for retrieving data objects requested by said database management node from said object store and placing said requested data objects within said cache memory, whereby data objects retrieved from higher cost object store storage tiers are placed in cache zones having lower I/O latencies.

2. The system according to claim 1, wherein said object store is connected to said database management store through a network.

3. The system according to claim 2, wherein said object store is a cloud storage.

4. The system according to claim 1, wherein said cache comprises different memory devices having respective different input/output (I/O) latencies with respect to data access.

5. The system according to claim 4, wherein different memory devices include non-volatile memory express (NVME) devices, SSD storage devices, and disc drives.

6. The system according to claim 4, wherein:
said cache comprises a virtual cache; and
said system further includes a configuration tool for mapping said different memory devices into said cache zones.

7. A system comprising:
a database management node including a processor, a non-transitory storage medium containing instructions executable on said processor, and a cache memory, said cache memory having multiple cache zones providing different input/output (I/O) latencies with respect to cache data access;
an object store remotely accessible by said database management node for the storage of data objects;
a pricing matrix containing access costs associated with data objects saved within said object store; and
said instructions executable on said processor include instructions for retrieving data objects requested by said database management node from said object store; obtaining access costs associated with data objects retrieved from said object store from said pricing matrix; and placing retrieved data objects having higher access costs in cache zones having lower I/O latencies.

8. The system according to claim 7, wherein access costs associated with a data object and maintained within said pricing matrix are determined by identifying at least one of the following factors associated with the data object:
said object is a cross region object;
said object is from a premium storage tier;
said object is a cross vendor object; and
said object is accessed from an internet compute node.

9. The system according to claim 7, wherein said instructions executable on said processor include instructions for eviction of lower cost data objects from said cache memory to make cache space available for a retrieved data object having a higher cost.

10. The system according to claim 7, wherein said object store is connected to said database management store through a network.

11. The system according to claim 10, wherein said object store is a cloud storage.

12. A method for caching data objects within a database management node, said database management node including a processor, a non-transitory storage medium containing instructions executable on said processor, and a cache memory, said cache memory having multiple cache zones providing different input/output (I/O) latencies with respect to cache data access; the method comprising the steps:
retrieving one or more data objects from an object store remotely accessible to the database management node, said object store including multiple storage tiers for storage of data objects, said storage tiers providing different input/output (I/O) latencies and costs with respect to data object access and storage; and
placing said retrieved data objects within said cache memory, whereby data objects retrieved from higher cost object store storage tiers are placed in cache zones having lower I/O latencies.

13. The method according to claim 12, wherein said object store is connected to said database management store through a network.

14. The method according to claim 13, wherein said object store is a cloud storage.

15. The method according to claim 12, wherein said cache comprises different memory devices having respective different input/output (I/O) latencies with respect to data access.

16. The method according to claim 15, wherein different memory devices include non-volatile memory express (NVME) devices, SSD storage devices, and disc drives.

17. The method according to claim 15, wherein:
said cache comprises a virtual cache; and
said system further includes a configuration tool for mapping said different memory devices into said cache zones.

18. A method for caching data objects within a database management node, said database management node including a processor, a non-transitory storage medium containing instructions executable on said processor, and a cache memory, said cache memory having multiple cache zones providing different input/output (I/O) latencies with respect to cache data access; the method comprising the steps:
retrieving one or more data objects from an object store remotely accessible to the database management node, said object store including multiple storage tiers for storage of data objects, said storage tiers providing different input/output (I/O) latencies and costs with respect to data object access and storage; and
maintaining access costs associated with data objects saved within said object store within a pricing matrix;
obtaining access costs associated with data objects retrieved from said object store from said pricing matrix; and placing retrieved data objects having higher access costs in cache zones having lower I/O latencies.

19. The method according to claim 18, wherein access costs associated with a data object and maintained within said pricing matrix are determined by identifying at least one of the following factors associated with the data object:
said object is a cross region object;
said object is from a premium storage tier;
said object is a cross vendor object; and
said object is accessed from an internet compute node.

20. The method according to claim 18, further comprising the step of evicting lower cost data objects from said cache memory to make cache space available for a retrieved data object having a higher associated cost.

21. The method according to claim 18, wherein said object store is connected to said database management store through a network.

22. The method according to claim 21, wherein said object store is a cloud storage.
